(19) United States
(12) Patent Application Publication
(10) Pub. No.: US 2024/0264051 A1
(43) Pub. Date: Aug. 8, 2024

(54) PHYSICAL SIMULATION METHOD FOR FORGING PROCESS OF NICKEL-BASE SUPERALLOY

(71) Applicant: JIANGSU UNIVERSITY, Zhenjiang (CN)

(72) Inventors: Wei LIN, Zhenjiang (CN); Rui LUO, Zhenjiang (CN); Qingtao LIU, Zhenjiang (CN); Xiaonong CHENG, Zhenjiang (CN); Yuyan YANG, Zhenjiang (CN); Zhou ZHOU, Zhenjiang (CN)

(73) Assignee: JIANGSU UNIVERSITY, Zhenjiang (CN)

(21) Appl. No.: 18/575,801

(22) PCT Filed: May 30, 2023
(86) PCT No.: PCT/CN2023/097157

§ 371 Date: Dec. 29, 2023

(30) Foreign Application Priority Data
Aug. 11, 2022 (CN) 202210962689.0

(51) Int. Cl. G01N 1/44; C22F 1/00; C22F 1/10

(52) U.S. Cl. CPC G01N 1/44; C22F 1/002; C22F 1/10

(57) ABSTRACT

A physical simulation method for a forging process of a nickel-base superalloy includes: subjecting a nickel-base superalloy sample to heating, heat preservation, and quenching successively to obtain a pretreated sample; and subjecting the pretreated sample to heating, first heat preservation, cooling, repeated compression-cooling treatments, second heat preservation, and quenching successively to obtain a simulated sample, where the compression-cooling treatments are repeated at least three times. In the physical simulation method, multi-pass compression-cooling deformation is adopted to simulate a forging process of a nickel-base superalloy, and this forging simulation method is close to an actual forging process, has an excellent simulation effect and high operability, and involves simple operations. The physical simulation method is suitable for a variety of nickel-base superalloys of a same forging method. The simulated sample is not much different from a same part of a forging obtained after actual forging in terms of a structure and hardness.

### CROSS REFERENCE TO THE RELATED APPLICATIONS

This application is the national phase entry of International Application No. PCT/CN2023/097157, filed on Jun. 28, 2023, which is based upon and claims priority to Chinese Patent Application No. 202210962689.0, filed on Aug. 11, 2022, the entire contents of which are incorporated herein by reference.

### TECHNICAL FIELD

The present disclosure belongs to the technical field of metal material processing, and in particular relates to a physical simulation method for a forging process of a nickel-base superalloy.

### BACKGROUND

As a forming process for metal materials, forging provides a strong support for the manufacture of large-size components and the production of high-end structural metal materials, and has been greatly promoted and used worldwide. Nickel-base superalloy GH4169 is widely used in aerospace, petrochemical oil fields, high-end molds, and other key components due to its excellent high-temperature strength, oxidation resistance, and durability. The forming of large-size shaft components and large-size parts needs to meet the requirements of structural uniformity and excellent properties to ensure a service life. However, the establishment of a forging process for these large-size forgings and the physical simulation of the forging process is a major problem. The improper establishment of a forging process will lead to structural non-uniformity of a large-size forging, such that different parts of the large-size forging have different properties, which easily fails to meet service conditions and has an impact on the service of large-size key devices such as aerospace vehicles.

At present, common methods for physical simulation of a forging process for a large-size forging include single-pass deformation, isothermal deformation, and cooling single-pass deformation. The single-pass deformation only involves one deformation during simulation for a forging process of a large-size forging, and cannot simulate the influence of a plurality of deformations on a structure of a material. Thus, the single-pass deformation contributes little to the establishment of a forging process. The isothermal deformation only allows simulation for an extremely-short forging process with an extremely-high forging speed. During the isothermal deformation, the heat of a superalloy loses fast in the air, and the contact between a component and a forging hammer during a deformation will also cause a temperature change of a material. Thus, the isothermal deformation is only suitable for a small-scale forging process, and cannot simulate the influence of cooling on a structure of a material during a forging process of a large-size forging. In addition, the simulation of a forging process by the isothermal deformation is impractical. The cooling single-pass deformation is a novel forging simulation method, which takes into account the cooling of a material during a forging process. However, the consideration of only cooling of a single pass is still prone to a discrepancy between a simulation result and an actual forging result.

None of the above simulation methods can accurately simulate a forging process, leading to simulation results quite different from actual forging results, and the above simulation methods cannot effectively guide the forging of a nickel-base superalloy. Therefore, it is urgent to provide a simulation method that is very close to an actual forging process.

### SUMMARY

In view of this, the present disclosure provides a physical simulation method for a forging process of a nickel-base superalloy. The physical simulation method provided by the present disclosure is close to an actual forging process, has an excellent simulation effect and high operability, and can effectively guide the forging of a nickel-base superalloy.

To achieve the above objective of the present disclosure, the present disclosure provides the following technical solutions.

The present disclosure provides a physical simulation method for a forging process of a nickel-base superalloy, including the following steps:
(1) subjecting a nickel-base superalloy sample to heating, heat preservation, and quenching successively to obtain a pretreated sample; and
(2) subjecting the pretreated sample to heating, first heat preservation, cooling, repeated compression-cooling treatments, second heat preservation, and quenching successively to obtain a simulated sample,
where in the step (1), the heat preservation is conducted at 1,020° C. to 1,080° C. for 30 min to 200 min; and
in the step (2), the first heat preservation is conducted at 1,020° C. to 1,050° C. for 60 s to 300 s; the second heat preservation is conducted at 950° C. to 1,050° C. for 60 s to 300 s; and
the compression-cooling treatments are repeated at least three times, where each of the compression-cooling treatments includes compression and cooling that are conducted successively, an engineering deformation amount during the compression each time is 10% to 30%, a temperature drop during the cooling each time is 10° C. to 30° C., and the cooling is followed by the compression until final cooling is completed.

Preferably, the nickel-base superalloy is a nickel-base superalloy GH4169, Inconel 625, or Inconel 718.

Preferably, the nickel-base superalloy sample is a cylindrical sample with a diameter of 6 mm to 10 mm and a length of 10 mm to 20 mm.

Preferably, a rate of the heating in the step (1) is 8° C./min to 10° C./min.

Preferably, for the quenching in the step (1), a quenching medium is water and a quenching rate is 50° C./s to 100° C./s.

Preferably, a rate of the heating in the step (2) is 8° C./s to 10° C./s.

Preferably, the compression-cooling treatments are repeated three to five times.

Preferably, the compression in the repeated compression-cooling treatments is conducted at a temperature of 950° C. to 1,050° C., and the temperature decreases gradually each time; the compression is conducted under a pressure of 1,000 kgf to 2,000 kgf for 2 s to 10 s each time; and the cooling in the repeated compression-cooling treatments is conducted for 5 s to 30 s each time.

Preferably, in the step (2), the quenching is vacuum gas quenching, and the quenching is conducted for 20 s to 40 s with a quenching endpoint temperature of 100° C. to 200° C.

The present disclosure also provides a simulated sample obtained by the physical simulation method described in the above solutions.

The present disclosure provides a physical simulation method for a forging process of a nickel-base superalloy, including the following steps: (1) subjecting a nickel-base superalloy sample to heating, heat preservation, and quenching successively to obtain a pretreated sample; and (2) subjecting the pretreated sample to heating, first heat preservation, cooling, repeated compression-cooling treatments, second heat preservation, and quenching successively to obtain a simulated sample, where in the step (1), the heat preservation is conducted at 1,020° C. to 1,080° C. for 30 min to 200 min; and in the step (2), the first heat preservation is conducted at 1,020° C. to 1,050° C. for 60 s to 300 s; the second heat preservation is conducted at 950° C. to 1,050° C. for 60 s to 300 s; and the compression-cooling treatments are repeated at least three times, where each of the compression-cooling treatments includes compression and cooling that are conducted successively, an engineering deformation amount during the compression each time is 10% to 30%, a temperature drop during the cooling each time is 10° C. to 30° C., and the cooling is followed by the compression until final cooling is completed. In the present disclosure, multi-pass compression-cooling deformation is adopted to simulate a forging process of a nickel-base superalloy, and a number of compression passes and a degree of cooling during a simulation process are controlled, which not only ensures the simulation of multi-forging of a forging, but also takes into account the fact that the cooling of a material will impact a structure of the material during a forging process. In the present disclosure, a multi-pass compression simulation manner is adopted to simulate a multi-deformation process of a blank by a hammer during a forging process, and a cooling deformation simulation manner is adopted to simulate a process in which a temperature change of a material during deformation causes structural non-uniformity of the material. The physical simulation method of the present disclosure involves simple operations, is close to an actual forging process, and has an excellent simulation effect and high operability. The physical simulation method of the present disclosure is suitable for a variety of nickel-base superalloys of a same forging method. A simulated sample produced by the physical simulation method of the present disclosure is not much different from a same part of a forging obtained after actual forging in terms of a structure and hardness. In a practical application process of the present disclosure, an actual forging process of large-scale forging for a nickel-base superalloy can be determined according to a result obtained by the physical simulation method of the present disclosure, including determining a temperature range (temperatures of initial and finish forging), a deformation amount of forging, or the like. Therefore, the physical simulation method of the present disclosure can effectively guide a forging process of a nickel-base superalloy. The embodiment results show that a simulated sample produced by the forging simulation method provided in the present disclosure is close to an actual forging result in terms of a structure, where a grain size difference between same parts of the two is less than 1 grade, and a hardness difference between same parts of the two is less than 25 HBW.

### BRIEF DESCRIPTION OF THE DRAWINGS

FIG. 1 is a schematic diagram of an observation surface for a structure of a physically-simulated sample.

FIG. 2 is a comparison diagram of structures of same parts of a simulated sample (left) obtained in Example 1 and an actual forged sample (right).

FIG. 3 is a comparison diagram of structures of same parts of a simulated sample (left) obtained in Example 2 and an actual forged sample (right).

FIG. 4 is a comparison diagram of structures of same parts of a simulated sample (left) obtained in Example 3 and an actual forged sample (right).

FIG. 5 is a comparison diagram of structures of same parts of a simulated sample (left) obtained in Example 4 and an actual forged sample (right).

### DETAILED DESCRIPTION OF THE EMBODIMENTS

The present disclosure provides a physical simulation method for a forging process of a nickel-base superalloy, including the following steps.
(1) a nickel-base superalloy sample is subjected to heating, heat preservation, and quenching successively to obtain a pretreated sample; and
(2) the pretreated sample is subjected to heating, first heat preservation, cooling, repeated compression-cooling treatments, second heat preservation, and quenching successively to obtain a simulated sample,
where in the step (1), the heat preservation is conducted at 1,020° C. to 1,080° C. for 30 min to 200 min; and
in the step (2), the first heat preservation is conducted at 1,020° C. to 1,050° C. for 60 s to 300 s; the second heat preservation is conducted at 950° C. to 1,050° C. for 60 s to 300 s; and
the compression-cooling treatments are repeated at least three times, where each of the compression-cooling treatments includes compression and cooling that are conducted successively, an engineering deformation amount during the compression each time is 10% to 30%, a temperature drop during the cooling each time is 10° C. to 30° C., and the cooling is followed by the compression until final cooling is completed.

In the present disclosure, the nickel-base superalloy sample is subjected to heating, heat preservation, and quenching successively to obtain a pretreated sample. In the present disclosure, the nickel-base superalloy is preferably a nickel-base superalloy GH4169, Inconel 625, or Inconel 718; and the nickel-base superalloy sample is preferably a cylindrical sample, and the cylindrical sample has a diameter of preferably 6 mm to 10 mm and more preferably 8 mm and a length of preferably 10 mm to 20 mm and more preferably 12 mm to 15 mm. In the present disclosure, when an original size of the nickel-base superalloy does not meet the above conditions, the nickel-base superalloy is preferably processed. The present disclosure does not have a special restriction on a manner of the processing, as long as a sample of the above size can be obtained. In a specific embodiment of the present disclosure, a wire-cutting machine tool is preferably used to process the nickel-base superalloy. In the present disclosure, a size of a simulated sample is controlled to facilitate the subsequent structural observation.

In the present disclosure, for the heating in the step (1), a rate is preferably 8° C./min to 10° C./min, a start temperature is room temperature, and an endpoint temperature is a temperature of the heat preservation in the step (1); the heat preservation in the step (1) is conducted at 1,020° C. to 1,080° C. and preferably 1,020° C. to 1,040° C. for 30 min to 200 min and preferably 50 min to 150 min; the heating and the heat preservation in the step (1) both are preferably conducted in a resistance-heating heat-treating furnace. In the step (1), after the heat preservation is completed, the quenching is conducted (which is recorded as first quenching), and for the first quenching, a quenching medium is preferably water, a quenching rate is preferably 50° C./s to 100° C./s, and a quenching endpoint temperature is preferably 50° C. to 100° C. In the present disclosure, the nickel-base superalloy sample is pretreated through the heating, heat preservation, and first quenching, which can regulate a grain size of the original sample, make grain sizes in the pretreated sample basically consistent, and remove a stress inside the material to improve the consistency of the material and prevent a structure of the material from being affected by a residual stress, thereby further improving the accuracy and consistency of forging simulation. In a specific embodiment of the present disclosure, the nickel-base superalloy sample is preferably placed near a temperature-measuring couple in a resistance-heating heat-treating furnace, and a heat-treating furnace in which a temperature can be well maintained is adopted, which can improve the grain size consistency of the material.

In the present disclosure, after the pretreated sample is obtained, the pretreated sample is subjected to heating, first heat preservation, cooling, repeated compression-cooling treatments, second heat preservation, and quenching successively to obtain a simulated sample. In the present disclosure, for the heating in the step (2), a rate is preferably 8° C./s to 10° C./s and more preferably 9° C./s to 10° C./s, a start temperature is room temperature, and an endpoint temperature is a temperature of the first heat preservation; the first heat preservation is conducted at 1,020° C. to 1,050° C. and preferably 1,030° C. to 1,040° C. for 60 s to 300 s and preferably 100 s to 250 s; and after the first heat preservation is completed, the cooling is conducted, and specifically, it is cooled to a temperature of the first compression at a rate of preferably 0.5° C./s to 5° C./s.

In the present disclosure, the compression-cooling treatments are repeated 3 or more times and preferably 3 to 5 times, where each of the compression-cooling treatments includes compression and cooling that are conducted successively, an engineering deformation amount during the compression each time is 10% to 30% and preferably 15% to 35%, a temperature drop during the cooling each time is 10° C. to 30° C. and preferably 20° C., and the cooling is followed by the compression (that is, an endpoint temperature of the current cooling is a temperature of the next compression) until the last cooling is completed. In the present disclosure, compression in the repeated compression-cooling treatments is conducted at a temperature of preferably 950° C. to 1,050° C., and the temperature decreases gradually each time (a temperature difference between two adjacent compression treatments is a temperature drop of cooling); and the compression is conducted under a pressure of preferably 1,000 kgf to 2,000 kgf and more preferably 1,500 kgf to 2,000 kgf. In the present disclosure, a fixed pressure is applied during compression for forging simulation to make a material well deformed. In the present disclosure, compression in the repeated compression-cooling treatments is conducted for preferably 2 s to 10 s and more preferably 3 s to 8 s each time; and cooling in the repeated compression-cooling treatments is conducted for 5 s to 30 s each time at a rate of preferably 0.5° C./s to 5° C./s.

The repeating process of the present disclosure is illustrated with three repeated compression-cooling treatments as an example: first compression, first cooling, second compression, second cooling, third compression, and third cooling are conducted successively, where if the first compression is conducted at 1,040° C. and a temperature drop during the cooling each time is 20° C., for example, then the first compression, the second compression, and the third compression are conducted at 1,040° C., 1,020° C., and 1,000° C., respectively, and after the third compression is completed, it is cooled to 980° C., such that the three compression-cooling treatments are completed.

After the repeated compression-cooling treatments are completed, the resulting sample is subjected to the second heat preservation. In the present disclosure, the second heat preservation is conducted at 950° C. to 1,050° C. and preferably 950° C. to 1,020° C., and the second heat preservation is conducted for 60 s to 300 s, preferably 100 s to 300 s, and more preferably 200 s to 300 s. In the present disclosure, parameters in a forging simulation process can be controlled to further improve the accuracy and consistency of a simulation result, thereby further improving a quality of forging simulation.

In a specific embodiment of the present disclosure, the heating, the first heat preservation, the cooling, the repeated compression-cooling treatments, and the second heat preservation in the step (2) all are preferably conducted in a Gleeble-3500 thermal simulator. Specifically, the pretreated sample is placed between a left pressure head and a right pressure head of the Gleeble-3500 thermal simulator with the pretreated sample axially centered between the pressure heads, and the pretreated sample is allowed to be in contact with the pressure heads by moving an active die end; and then the heating, the first heat preservation, the cooling, the repeated compression-cooling treatments, and the second heat preservation are conducted successively by the Gleeble-3500 thermal simulator, where after the repeated compression-cooling treatments are completed, it is directly heated by the Gleeble-3500 thermal simulator to a temperature of the second heat preservation at a rate of preferably 8° C./s to 12° C./s and more preferably 10° C./s. The present disclosure does not have a special restriction on a specific source of the Gleeble-3500 thermal simulator, and a commercially-available product well known to those skilled in the art may be adopted. In the present disclosure, when the Gleeble simulator is used for forging simulation, process parameters can be accurately controlled to obtain a desired simulation process. The present disclosure does not have a special restriction on a manner of pressure relief after each compression is completed, and the pressure relief can be allowed by operating the Gleeble-3500 thermal simulator.

In the present disclosure, after the second heat preservation is completed, the resulting sample is subjected to quenching (which is recorded as second quenching), where the second quenching is preferably vacuum gas quenching, and the second quenching is conducted for preferably 20 s to 40 s and more preferably 30 s with a quenching endpoint temperature of preferably 100° C. to 200° C. and more preferably 100° C. to 150° C. In the present disclosure, parameters of the quenching can be controlled to further reduce the precipitation of a precipitated phase in a material during cooling and the recrystallization of grains of the material and simulate a physical state of the material at a high temperature. The present disclosure does not have a special restriction on a specific operation of the vacuum gas quenching, and a process of vacuum gas quenching well known to those skilled in the art may be adopted.

The present disclosure also provides a simulated sample obtained by the physical simulation method described in the above solutions, and the simulated sample obtained in the present disclosure is not much different from a same part of a forging obtained after forging in terms of a structure and hardness. Thus, the physical simulation method of the present disclosure can effectively guide a forging process of a nickel-base superalloy. In a practical application process, a forging process of large-scale forging for a nickel-base superalloy can be determined according to a simulation result of the present disclosure, including a temperature range of actual forging (temperatures of initial and finish forging), a deformation amount of forging, or the like, thereby effectively guiding the forging of the nickel-base superalloy.

The technical solutions of the present disclosure will be clearly and completely described below with reference to the examples of the present disclosure. Apparently, the described examples are merely some rather than all of the examples of the present disclosure. All other examples obtained by those of ordinary skill in the art based on the examples of the present disclosure without creative efforts shall fall within the protection scope of the present disclosure.

The nickel-base superalloy samples used in the following examples all are cylindrical samples each with a diameter of 10 mm and a length of 15 mm.

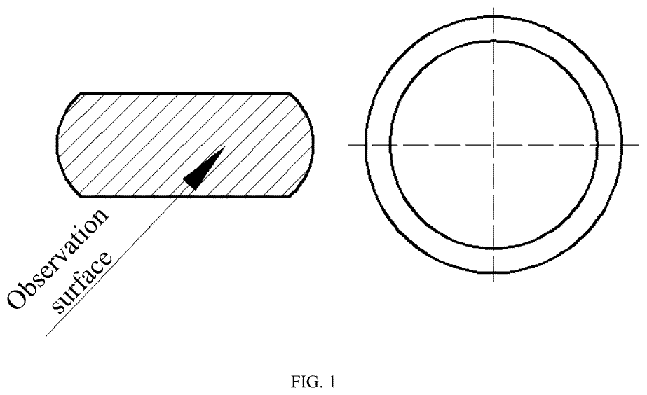

In the following examples, a structure of a prepared sample is tested, and a cross-sectional observation manner of the sample is shown in FIG. 1; and a simulated sample is machined to obtain a test sample for grain size testing, and then a grain size of the test sample is tested in accordance with the “GBT6394-2017 Determination Method for Average Grain Size of Metal”.

### Example 1

A nickel-base superalloy GH4169 sample was placed in a heat-treating furnace, heated at a rate of 10° C./min to 1,040° C., and then subjected to heat preservation for 60 min, and after the heat preservation was completed, the resulting sample was taken out and water-quenched immediately to obtain a pretreated sample.

The pretreated sample was placed between a left pressure head and a right pressure head of a Gleeble-3500 thermal simulator with the pretreated sample axially centered between the pressure heads, and the pretreated sample was allowed to be in contact with the pressure heads by moving an active die end. The pretreated sample was heated at a rate of 9° C./s to 1,050° C. and subjected to first heat preservation for 30 s, and then cooled to 1,040° C. The resulting sample was subjected to first compression and then cooled at a rate of 2° C./s for 10 s, and then subjected to subsequent 4 repeated compression-cooling treatments, where each compression was conducted under a pressure of 2,000 kgf with an engineering deformation amount of 15%; each cooling was conducted at a same rate for a same time; second compression to fifth compression were conducted at 1,020° C., 1,000° C., 980° C., and 960° C., respectively; and after the fifth compression was completed, it was cooled to 940° C. The resulting sample was heated to 1,000° C. and subjected to second heat preservation for 200 s. After the second heat preservation was completed, the resulting sample was subjected to vacuum gas quenching for 30 s with a quenching endpoint temperature of 100° C. to obtain a simulated sample.

It was observed that the simulated sample had a similar structure to an actual forged sample (an initial forging temperature was 1,040° C., a finish forging temperature was 960° C., a deformation amount during each forging was 15%, and after five times of deformation, the resulting sample was reheated and subjected to heat preservation for 10 min), where a grain size difference between same parts of the two was less than 1 grade, and a hardness difference between same parts of the two was 18 HBW.

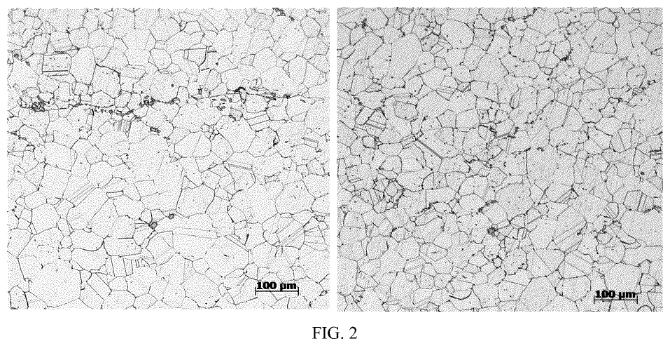

FIG. 2 is a comparison diagram of structures of same parts of a simulated sample (left) obtained in Example 1 and an actual forged sample (right), and it can be seen that a grain size of the simulated sample is at a grade 5.5 and a grain size of the actual forged sample is at a grade 6.

### Example 2

A nickel-base superalloy GH4169 sample was placed in a heat-treating furnace, heated at a rate of 10° C./min to 1,020° C., and then subjected to heat preservation for 120 min, and after the heat preservation was completed, the resulting sample was taken out and water-quenched immediately to obtain a pretreated sample.

The pretreated sample was placed between a left pressure head and a right pressure head of a Gleeble-3500 thermal simulator with the pretreated sample axially centered between the pressure heads, and the pretreated sample was allowed to be in contact with the pressure heads by moving an active die end. The pretreated sample was heated at a rate of 10° C./s to 1,030° C. and subjected to first heat preservation for 60 s, and then cooled to 1,020° C. The resulting sample was subjected to first compression and then cooled at a rate of 1° C./s for 20 s, and then subjected to subsequent 2 repeated compression-cooling treatments, where each compression was conducted under a pressure of 1,500 kgf with an engineering deformation amount of 18%; each cooling was conducted at a same rate for a same time; second compression and third compression were conducted at 1,000° C. and 980° C., respectively; and after the third compression was completed, it was cooled to 960° C. The resulting sample was heated to 980° C. and subjected to second heat preservation for 250 s. After the second heat preservation was completed, the resulting sample was subjected to vacuum gas quenching for 30 s with a quenching endpoint temperature of 120° C. to obtain a simulated sample.

It was observed that the simulated sample had a similar structure to an actual forged sample (an initial forging temperature was 1,020° C., a finish forging temperature was 980° C., a deformation amount during each forging was 18%, and after three times of deformation, the resulting sample was reheated and subjected to heat preservation for 10 min), where a grain size difference between same parts of the two was less than 1 grade, and a hardness difference between same parts of the two was 14 HBW.

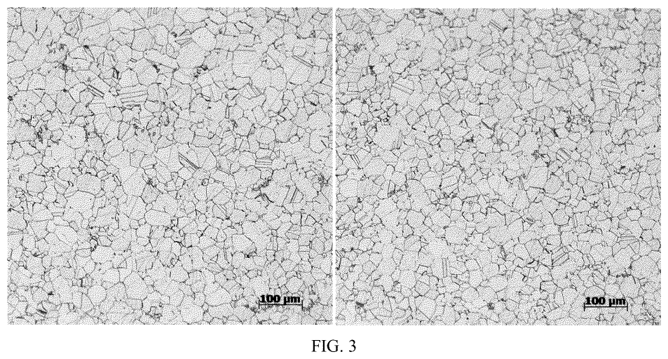

FIG. 3 is a comparison diagram of structures of same parts of a simulated sample (left) obtained in Example 2 and an actual forged sample (right), and it can be seen that a grain size of the simulated sample is at a grade 6.5 and a grain size of the actual forged sample is at a grade 7.

### Example 3

This example was the same as Example 1 except that the nickel-base superalloy GH4169 was replaced by Inconel 625.

It was observed that the simulated sample had a similar structure to an actual forged sample (whose forging conditions were the same as the forging conditions for the actual forged sample in Example 1), where a grain size difference between same parts of the two was less than 1 grade, and a hardness difference between same parts of the two was 22 HBW.

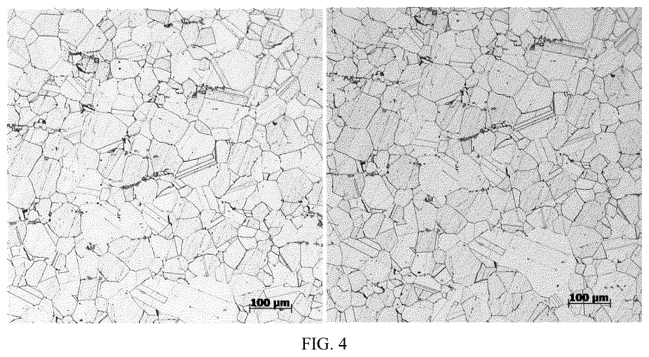

FIG. 4 is a comparison diagram of structures of same parts of a simulated sample (left) obtained in Example 3 and an actual forged sample (right), and it can be seen that a grain size of the simulated sample is at a grade 5 and a grain size of the actual forged sample is at a grade 5.5.

### Example 4

This example was the same as Example 2 except that the nickel-base superalloy GH4169 was replaced by Inconel 718.

It was observed that the simulated sample had a similar structure to an actual forged sample (whose forging conditions were the same as the forging conditions for the actual forged sample in Example 2), where a grain size difference between same parts of the two was less than 1 grade, and a hardness difference between same parts of the two was 16 HBW.

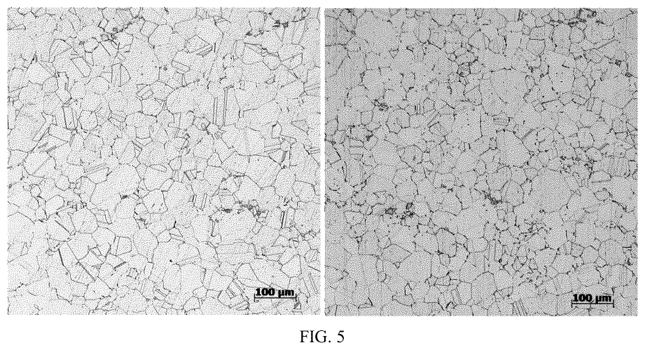

FIG. 5 is a comparison diagram of structures of same parts of a simulated sample (left) obtained in Example 4 and an actual forged sample (right), and it can be seen that a grain size of the simulated sample is at a grade 6 and a grain size of the actual forged sample is at a grade 6.5.

The above are merely preferred implementations of the present disclosure. It should be noted that a person of ordinary skill in the art may further make several improvements and modifications without departing from the principle of the present disclosure, but such improvements and modifications should be deemed as falling within the protection scope of the present disclosure.

What is claimed is:

1. A physical simulation method for a forging process of a nickel-base superalloy, comprising the following steps:
(1) subjecting a nickel-base superalloy sample to heating, heat preservation, and quenching successively to obtain a pretreated sample; and
(2) subjecting the pretreated sample to heating, first heat preservation, cooling, repeated compression-cooling treatments, second heat preservation, and quenching successively to obtain a simulated sample,
wherein in the step (1), the heat preservation is conducted at 1,020° C. to 1,080° C. for 30 min to 200 min; and
in the step (2), the first heat preservation is conducted at 1,020° C. to 1,050° C. for 60 s to 300 s; the second heat preservation is conducted at 950° C. to 1,050° C. for 60 s to 300 s; and
the compression-cooling treatments are repeated at least three times, wherein each of the compression-cooling treatments comprises compression and cooling that are conducted successively, an engineering deformation amount during the compression each time is 10% to 30%, a temperature drop during the cooling each time is 10° C. to 30° C., and the cooling is followed by the compression until final cooling is completed.

2. The physical simulation method according to claim 1, wherein the nickel-base superalloy is a nickel-base superalloy GH4169, Inconel 625, or Inconel 718.

3. The physical simulation method according to claim 1, wherein the nickel-base superalloy sample is a cylindrical sample with a diameter of 6 mm to 10 mm and a length of 10 mm to 20 mm.

4. The physical simulation method according to claim 1, wherein a rate of the heating in the step (1) is 8° C./min to 10° C./min.

5. The physical simulation method according to claim 1, wherein for the quenching in the step (1), a quenching medium is water and a quenching rate is 50° C./s to 100° C./s.

6. The physical simulation method according to claim 1, wherein a rate of the heating in the step (2) is 8° C./s to 10° C./s.

7. The physical simulation method according to claim 1, wherein the compression-cooling treatments are repeated three to five times.

8. The physical simulation method according to claim 1, wherein the compression in the repeated compression-cooling treatments is conducted at a temperature of 950° C. to 1,050° C., and the temperature decreases gradually each time; the compression is conducted under a pressure of 1,000 kgf to 2,000 kgf for 2 s to 10 s each time; and the cooling in the repeated compression-cooling treatments is conducted for 5 s to 30 s each time.

9. The physical simulation method according to claim 1, wherein in the step (2), the quenching is vacuum gas quenching, and the quenching is conducted for 20 s to 40 s with a quenching endpoint temperature of 100° C. to 200° C.

10. A simulated sample obtained by the physical simulation method according to claim 1.

11. The physical simulation method according to claim 2, wherein the nickel-base superalloy sample is a cylindrical sample with a diameter of 6 mm to 10 mm and a length of 10 mm to 20 mm.

12. The physical simulation method according to claim 7, wherein the compression in the repeated compression-cooling treatments is conducted at a temperature of 950° C. to 1,050° C., and the temperature decreases gradually each time; the compression is conducted under a pressure of 1,000 kgf to 2,000 kgf for 2 s to 10 s each time; and the cooling in the repeated compression-cooling treatments is conducted for 5 s to 30 s each time.

13. The simulated sample according to claim 10, wherein the nickel-base superalloy is a nickel-base superalloy GH4169, Inconel 625, or Inconel 718.

14. The simulated sample according to claim 10, wherein the nickel-base superalloy sample is a cylindrical sample with a diameter of 6 mm to 10 mm and a length of 10 mm to 20 mm.

15. The simulated sample according to claim 10, wherein a rate of the heating in the step (1) is 8° C./min to 10° C./min.

16. The simulated sample according to claim 10, wherein for the quenching in the step (1), a quenching medium is water and a quenching rate is 50° C./s to 100° C./s.

17. The simulated sample according to claim 10, wherein a rate of the heating in the step (2) is 8° C./s to 10° C./s.

18. The simulated sample according to claim 10, wherein the compression-cooling treatments are repeated three to five times.

19. The simulated sample according to claim 10, wherein the compression in the repeated compression-cooling treatments is conducted at a temperature of 950° C. to 1,050° C., and the temperature decreases gradually each time; the compression is conducted under a pressure of 1,000 kgf to 2,000 kgf for 2 s to 10 s each time; and the cooling in the repeated compression-cooling treatments is conducted for 5 s to 30 s each time.

20. The simulated sample according to claim 10, wherein in the step (2), the quenching is vacuum gas quenching, and the quenching is conducted for 20 s to 40 s with a quenching endpoint temperature of 100° C. to 200° C.
